(19) United States
(12) Patent Application Publication
(10) Pub. No.: US 2002/0062243 A1
(43) Pub. Date: May 23, 2002

(54) Method

(76) Inventor: Kent G. Anderson, Bismarck, ND (US)

Correspondence Address: KENT G. ANDERSON, 925 NGRIFFIN, BISMARCK, ND, 58501, US

(21) Appl. No.: 09/970,747

(22) Filed: Oct. 2, 2001

Related U.S. Application Data
(60) Provisional application No. 60/240,194, filed on Oct. 16, 2000.

(51) Int. Cl. G06F 17/60

(52) U.S. Cl. 705/10

(57) ABSTRACT

The method of and process of building businesses and doing business creations, etc. and the development of any and all ideas, goods and services that can be thought of and created by the human mind and can serve a purpose can be protected under the identify or name such as, for example, Future. Then market these in all marketing sectors, so forth, in building new products and services under the name Future and not limited to the name Future.

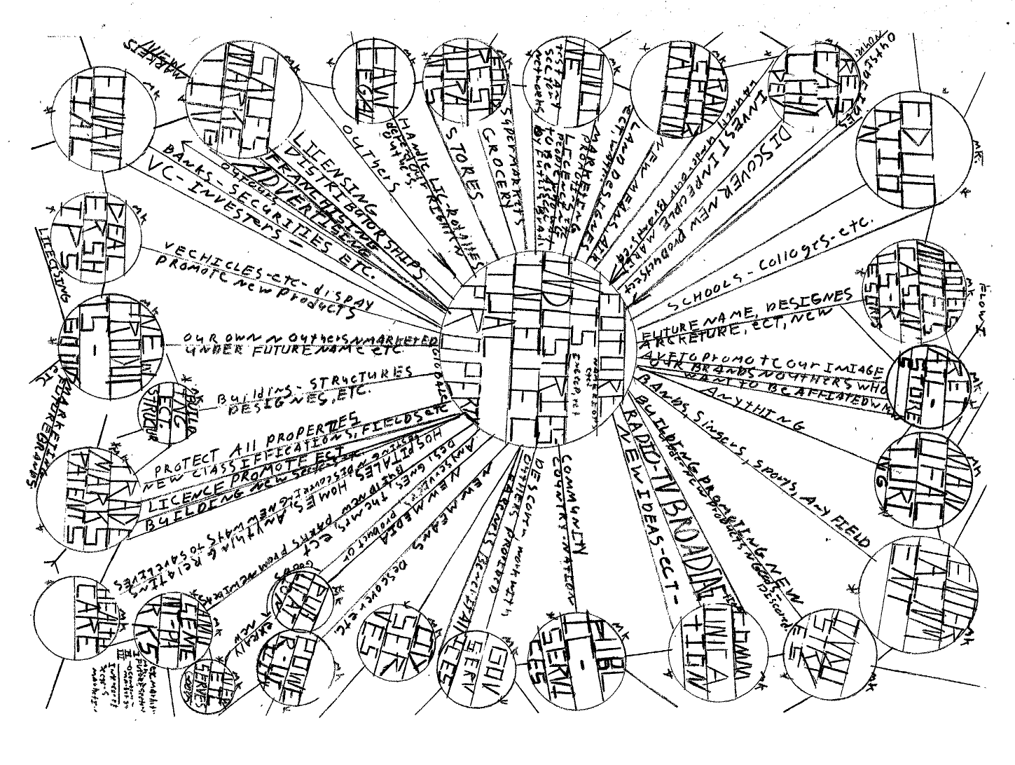

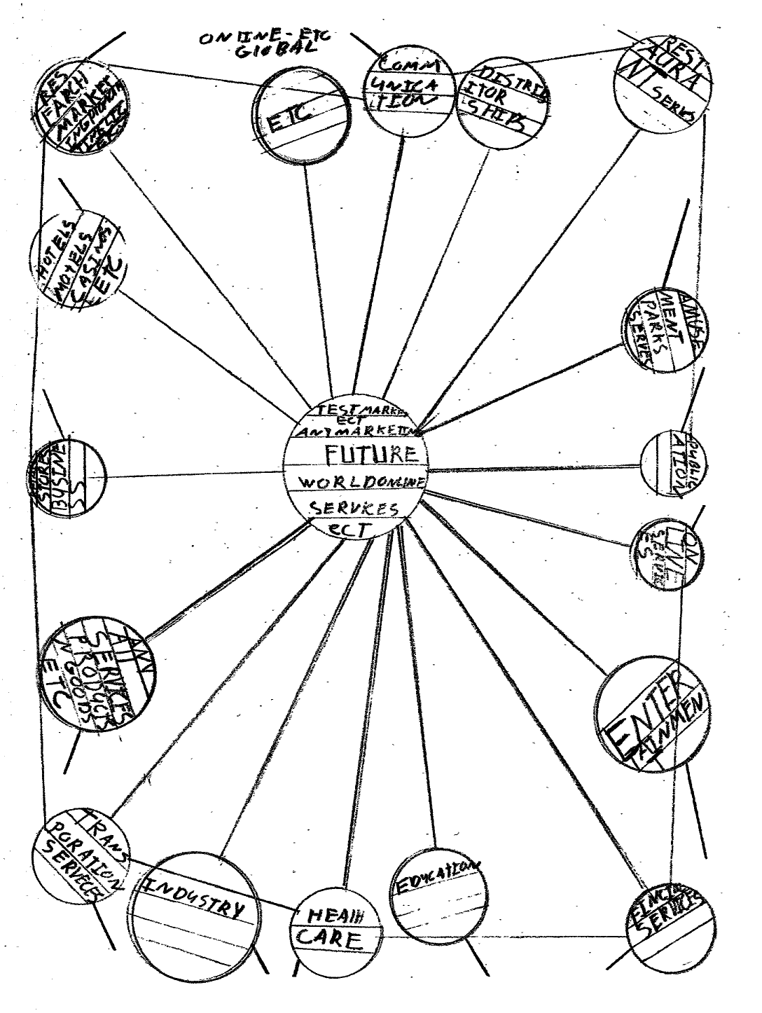

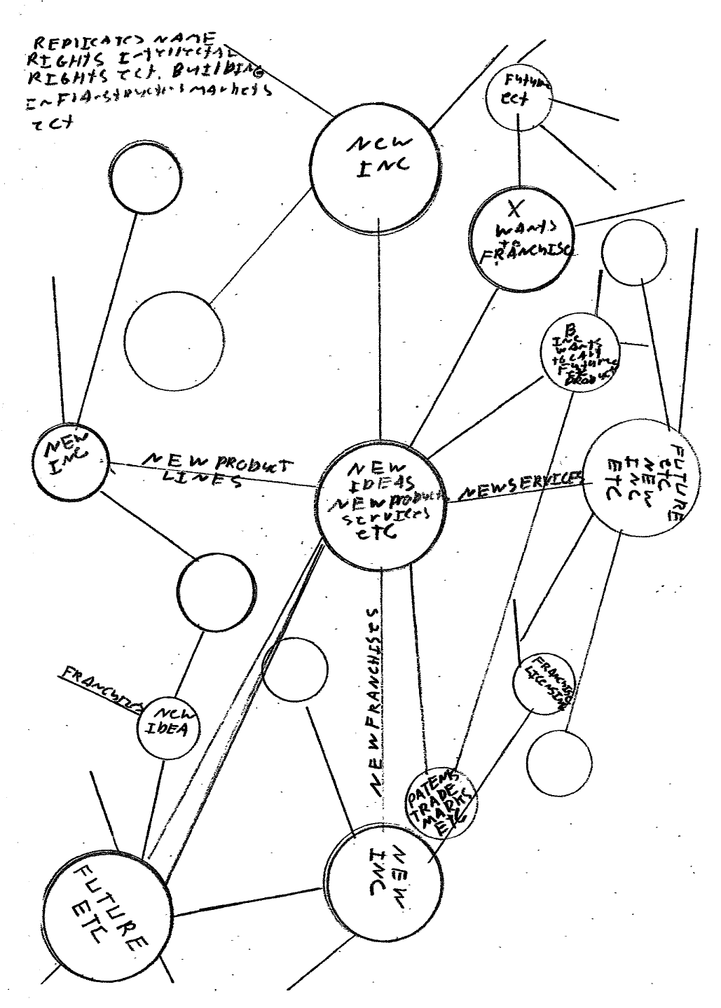

With these identities infrastructures will be built and interconnect with other infrastructures which deals with any and all products and services, especially new goods, products and services that can be discovered. These can be built around that identity, so on and so forth, for testing, manufacturing, promoting, marketing in all marketing sectors with the intent to develop new products and services, so on and so forth by providing a place to test and market by any and all means. The brand name Future and not limited to Future will identify unique products, services, markets and industries focusing on intellectual property ideas and will launch new products, services, and new industries by franchising the name with other entities and interconnecting all products, services, etc. to create large infrastructures where people can test and market their ideas.

In reference to the early filed application of Oct. 16, 2000 and application Ser. No. 60/240194

### BACKGROUND OF THE INVENTION

The present invention is to relate to the process of doing business and a method of building infrastructures, Future brands, etc and on-line huge infrastructures to market and to test ideas online in any marketplace with related protecting rights there of. The invention will identify any new markets built around any new products, services, etc., with testing, marketing and promoting etc. in any and all marketing sectors and markets. Identified markets will be built around those marketing sectors. The main scope of the invention is a method etc. of doing business in addition to stores and businesses that sell similar products. The difference is the design and the marketing and promoting of the same goods, as well as, a different name. There needs to be an open market to bring in new goods and products etc. with especially future related goods and products, thus making Future original in doing business with any business in any marketing sector.

Future deals with marketing any marketable product or goods especially in building new markets and products and services from the ideas people have and those ideas that have not even been discovered or developed yet. With these new ideas, Future will be bringing in new products and infrastructures in business in any marketing sector thereof which includes products, goods, services and trade from innovationive ideas of any person that encompasses an oral language, writing, touch or feel, written word and anything that can be protected related to and will be identified and marketed through a vast arena of interconnected infrastructures etc. anything of now and anything which deals with the future.

This is a complex intellectual property with rights and license in promoting and building of new infrastructures with new products and services by interconnecting huge infrastructures and by building infrastructure of Future brands etc. Identified will be any markets which deals with the new and not the old in which people can test ideas. Also identified will be the markets for launching new ideas, products and services in any market sectors set forth identified with new ideas, products and patents and with markets which build new company's products and services around those goods, products and services by identifing new classifications and new patent rights etc. to launch new ideas, products and services in any marketing sector set forth.

Included will be a huge project dealing with futuristic designs which also will encompass a place where people can test their ideas in any marketing sector. This place will encompass future themes for retail stores, hotels and motels. This place or a city which is identified with the name Future represents the research and industries dealing with any new product and/or service etc. Featured would be Future TV broadcasting, museums, theaters, retail stores, industries, research centers , manufacturing, and others. Again this is a place where people can test ideas in any marketing sector and meet business leaders who would test and place ideas into marketing into any marketing sector.

The business means and methods with identifying intellectual property rights will be the securing of the rights to the name of Future and to identify future rights to the name etc. and identifying future products, industries and markets as new intellectual property under the brand Future. Included will be the building of interconnecting infrastructures, the investing in intellectual properties of other entities and the identification of Future with the new ideas, products and services. All people will have a chance to bring in new ideas, products and services and to invest in these innovations. For people who want to be affiliated with the brands and the name or names which identifies Future, the name rights, intellectual property rights and methods will be secured which allow people to test these ideas including on-line for production and marketing in any marketing sector.

In the building of those markets etc. in the name Future around those sectors with new products and services, building themes in the market places and infrastructure will be futuristic in design. Products and services of any industry may be included in a futuristic designed like city where goods, services and industries can be launched and branched out to any marketing sector with building of infrastructures around the new products with Future brands and names. Included would be retail stores, entertainment sector, transportation services, industrial services, health care services, financial-services, etc. especially relating to and creating of new services and goods and products under the Future name etc. The intent is to build those sectors and markets and new markets under that name Future; to invest in people and their ideas in any marketing sector and to build those sectors that are new or not in existence at this time. This includes any company or industry that deals with goods/products and services thought of in the future. It deals with a thought that could be created into a service or product etc. and the design means for the products, the services and marketing with the ability to build a huge infrastructures around those new ideas and markets and so forth. The intent is to discover new products and intellectual property and build markets around those, such as, one of many examples is to provide the interconnecting of networks worldwide in order to read stories live via on-line to call upon those readers anywhere at any time to promote reading. Testing and marketing of people's ideas, providing and building new infrastructures and interconnecting with other infrastructures would include internet and new media services.

### SUMMARY OF THE INVENTION

This invention relates to process methods etc. of building and securing all intellectual property rights identified with Future trademark/trademarks rights and intellectual rights etc. which deals with now and of the future, especially the future services, goods, products and intellectual property. Protection of intellectual property rights to services products etc. of now and of the future will be secured with the rights to the name Future and by building industries and markets under the name. Also to be protected is the business method of testing products in any marketing sector including on-line services. This would include any ideas and products in any and all fields and markets and the on-line services, where ideas and products to be tested out electronically. This invention is a method of doing business by testing, producing, marketing, advertising, and building infrastructures markets and so forth. interconnecting infrastructures etc. markets and so forth.

For example, by interconnecting live story readers live via Internet called upon by clients worldwide, there can be accessed live stories read live in any language. through a web site which identifies and calls on specific readers. The invention of method will include with many examples and creations with many infrastructures, online and in the real world to test and to market any thing by any means or methods of creating new ideas.

The method of protecting intellectual property is by having any means in which to identify any services and goods and apply to online web page etc is only one example. Then have every goods and services listed be identified with the name and not limited to Future sm/tm. Usage will be shown with claiming rights, and licensing under intellectual property rights.

The following will help further explain the invention and the business methods; as follows, to build a place futuristic in designs and themes which encompasses any industry and services etc. and a place to launch new products and services with industries. Everything will be related to the future with a place like a futuristic city that encompasses research centers, industry and commerce, etc. especially focusing on and representing new goods or products that haven't been thought of or produced.

An object of the invention is the method of building a unique infrastructure in which to identify new products, process methods, intellectual properties and to launch new products and services under the Future name. Also markets will be identified and infrastructures built online to interconnect and allow ideas and products to be tested in any marketing sector. On-line interconnecting of networks will provide any means to test etc. people's ideas and Intellectual properties by any and all means and to build markets to license intellectual properties.

Another object of the invention is the methods-process of creating and securing legal rights to the use of the name Future with methods, intellectual properties, and in any marketing sector new products, new services, licenses, etc. for those goods and services that are created from new ideas, products and intellectial properties that are discovered and tested. Included will be the licensing of the new products, goods and services and the building of distribution channels etc. around those new markets, infrastructures, networks onine, so forth.

Another object of the invention is to build an infrastructure with infrastructures within for the different properties and intellectual properties and to create unique markets infrastructures with new franchises, rights, license and to build those markets around those sectors and so on.

Another object of invention is to provide infrastructures to test ideas, products, markets through any and all means including on-line with interconnecting infrastructures to build and launch new businesss, to license the rights and to build new markets around those sectors. Channel distributionships for new products and services will be created. Such as, an on-line connection of live story readers worldwide that can be called upon by those that want to hear the stories read in any language.

Another object Is to create new ideas and build new markets around those sectors with the interconnection of new and other infrastructures or enties that want to be associated with Furure. The object is to create infrastructures to test and market and to build new industries with products, goods and services.

Another object of the invention is the method of creating ideas for products for now and the future and of incorporating these ideas.

Another object of the invention is the method of protecting the name Future and to apply the name to those goods and services that shows usage with established legal rights, and to apply for that name for licensing of intellectual property.

Another object is the applying for licensing of intellectual property or properties under the name chosen especially Future. Licensing rights are currently available under the name Future.

### DETAILED DESCRIPTION OF THE INVENTION

Example 1 processmethod—is to build infrastructures by any and all means within a huge enity etc., toldentify rights products and services etc. that are new, and to build those infrastructures, methods, markets and products etc. around those entities thereof.

Example 2 process method—is to build and protect the name of Future etc. and the rights to identify products and services methods by the name etc. and to build new industries and markets under the name, etc., to create new ideas and markets etc., Indentify these entities by the Future name etc., to build these infrastructures around those entities and to provide an arena to test people's ideas in any marketing sector, to protect those rights dealing with any intellectual rights so on and to build infrastructures online and in the real world identifying new products and services and to build and interconnect those infrastructures and markets etc. by any and all means.

Examples 3 process method—is to create Future etc. entities in which to develop products and intellectual properties and to market those new products and services in any marketing sector by any and all methods interconnecting markets and infrastructures in any and all structures and markets etc.

Example 4 process method—is to build an infrastructure, a place, to identify many different entities services, goods and products etc., a place to test all ideas in any markings sector and a place to meet business leaders etc. Every detail of the futuristic type structure manufacturing, commerce etc. is futuristic in style. The city encompasses research centers, museum, theaters, retail stores, radio and TV broadcasting centers, so on. This includes any identifying services and any all classes and fields classified as such and any and all products, goods, or services that can be created and thought of now and for the future. Any services of Future can be in a superstructure. Every detail and related products will be futuristic and future-related. This would include new entertainment launching new promotions, new industrial promotion of goods promoting and launching of a product, goods, and service in any marketing sector. This is a place that will also have its own financial services with a Future bank that does not look at a person's assets but identifies them with the dreams and ideas. It is a place to meet financial partnersand leaders. In addition it is a place where to focus on the benefit for all people's needs and a place where we can work together for the benefit of all humankind.

Example 5 continued process method—any means to create new jobs Online with new opportunities. By connecting networks and online services new methods, new products and services will be created by the Future name etc. Included will be the building of channels for licensing, new infrastructures and new markets.

Example 6 process metod—securing the rights under name Future, and not limited to the name Future to include any marketings sector and to build new means, new products, new services, infrastructures and places and on-line, to provide a place where people can test Ideas in any marketing sector by any and all means and to launch new products under the Future name etc. Included are securing rights to unique markets around new products' names, intellectual propery, products, methods and interconnecting infrastructures etc. and so forth.

Example 7 process method—Is a method of creating in languages, writings, art, taste, touch, feel, and any means by which one can communicate ideas or inventions etc. New products etc. that can be created by the mind and invented for the human being and their surroundings, that has a use and can be used, created and sold can be identified by the name Future etc., By protecing intellectual property rights, markets and infrastructures can be built the aound new intellectual property etc., so forth any process method there of interconecting networks.

Example 8 process methods is the building of new markets from ideas, products and services and interconect marketing by building vast infrastructures which include methods, markets, and distributorships etc. which deals with any marketing sector any producter goods, anything that can be created, marketed and sold. These goods, products or services means can be identified by the name Future not limited to the name Future, etc. in a new means intellectual property and rights. Also many names can be attached on to the name Future thus providing more rights and ways in creating new products services by creating those markets and open structures around those ideas and sectors so forth.

Example 9 method process is creating a huge future means city with the future theme which is self-contained and operated by the occupants who have the goals and values to carry on to other generations of leaders and who care for all people for the benefit of our world:

Example 10 the method process is to create a means to allow people to test their ideas etc. by any electronic, by any and all means on-line et, and to interconnect other networks. Future will build a new world tm to create new products and services etc. and to build marketing channels, distributorships, and infrastructures etc. working with other entities and licensing, etc. for the benefit of all.

Example 10 is the method of securing legal rights and of showing usage of names by identifying every good, service, and marketing sector with the name with protection by sm, for example Future sm retail services, and so on. Then uage can be shown on-line with the ability to apply for intellectual property licensing, so on and so forth.

Now refering to the claims:

1 is a method process creating and building vast infrastructures, methods means, distributorships, markets, structures etc. in which to test people's ideas in any marketing sector and to market products, goods, and services in any marketing sector by building infrastructures and markets around any products, goods, markets and service—any thing that can be created. Included are online and on-line services interconnecting networks by means which will allow the testing of people's ideas, products, and goods by any and all means. Marketing and infrastructures around those new products, goods and services will be built.

2 the method process of building an establishment or city etc. which encompasses any industry and services dealing with any and all marketing sectors and of producing marketing, creating distributorships and infrastructures etc. under the Future, etc brand names. Included is the process of marketing products, goods and services etc. to others and the building of infrastructures around both said products and others so forth, around new products and services and Intellectual property discovered by the new ideas and new products. The method process will include the building of markets in infrastructures around those new ideas, products and intellectual property and so on.

3 is a process to create vast infrastructures methods where products and ideas etc. will be tested in any marketing sector by any and all means, and where future industries interconnects so they will remain with the main group and for investment with other companies. Future will be claiming new technology, market the products, finance the products, own channels and resources for license, market and test people's ideas in any marketing sector, and represent new ideas, new products and new intellectual property under the Future name, not limited to the Future name. Infrastructures, markets and franchises in infrastructures will build around new products, new patents, and new services and create and interconnect those markets so forth on-line to identify any services, goods, products and methods in which to test ideas anything in which can be thought of and created for any marketing sector.

4 the method process will include any and all infrastructures dealing with markets, distributorships sectors and any all fields which deal with any and all markets of products, goods and services especially relating to the future. The method etc will include any and all infrastructures that will discover new products and service markets etc. The name Future has rights in which the name also can be attached on to other names with more opportunities to launch new services etc. under the Future names. Legal rights to pattents trademarks and intellictial property from these properties will be secured.
Any invention or device that can be created and that can be marketed etc. and that serves a purpose can claim the right to Future etc brands intellectial properties. The building of new markets for new products, services, infrastructures, networking and marketing where people will test ideas, anything that can be thought of by any and all means will be included. Any and all products and services can be tested, promoted and marketed in any marketing sector with online and interconnecting networks by any and all means set forth with the usage of the name Future and marketing under licensing of intellectual property.

5 is the process method to build a new world brand name Future and not limited to the name Future will provide the opportunity to build new markets, products and services around newly discovered properties etc. and so forth through the interconnecting of networks and the building of new markets, new infrastructures, distributorships and the obtaining of trademark patent rights and intellectual rights around those newly discovered properties. Included is the connecting of those networks for products and services, franchising, licensing and distributing and building channels around those new discovered properties and to build a Futuristic city or establishment. where all services, products and goods will be identified. The city will encompass infrastructures for the retail sector, financial sector, museum sector, educational sector, health care sector, online sector, utility sector, hotels and motels, resorts sectors, industrial sector, research sector, entertainment sector, and every industry that markets any and all special services, goods and products. The city will be the place to meet business leaders who would look at people's dreams and their abilities. This company will have the ability of marketing their products in any marketing sector and on-line worldwide. Future deals with creating it own unique society that can be protected and serve the world in the future with the benefit to protect the knowledge of thinking positive with no prejudice and stand as one for our world. By marketing and producing products and distributing the new products and ideas includes the builiding of vast infrastructures and markets to test people's ideas in any marketing sector by any and all means to focus on the people's ideas and dreams. Any infranstructure will be built with these enties by using process method for interconnecting building, etc.

6 process method is a Futuristic city etc. on an island or elsewhere where the theme is Futuristic to be a place to test ideas for products and services in any and all marketing sectors, to provide franchise licising by any means, and to market to other entities. Opportunity will be available to work together to discover new services in healing techniques to save lives by securing the intellectial and copyrights, etc. to new products and services, to franchise those rights and distribute new products and services.
This entity or corporation will capture a unique market in which people will want to do business and to be identified with Future. Dealership for selling future leader automobiles, museum, libraries, retail stores, and other commerce medias will be components of the market. New sports ideas and new entertainment to launch and promote dance, artist, etc. under the Future brands will be possible. Products and services, etc. will have research centers. Utility companies and financial-services will be available. Business will on based on positive leadership values that are honorable. Focus is in building huge infrastructures with interconnecting networks by any and all means in which to test ideas and by any all means online such as to read stories live anywhere in the world which connects readers in any and all languages when called upon by clients. Also online will have interconnecting networks with any and all fields, classess, etc. which tests people's ideas on-line and in the retail industry in any and all sectors, there of.

7 process method is to promote in marketing Future brands and intellectial property Future brands in any and all marketing sectors. This includes products, goods and services etc. Intent is to develop, build, and promote market distributorships, to build new market infrastructures and to build these new markets with speciaty identification of the brands name and intellectual property with Future and not limited to the brand Future. Any methods, ways and means in which to build structures, test and market ideas and products etc. in any marketing sector will be used. Any ways or means to discover new products and develop intellectual property and to build new markets around those new goods, products, sevices and intellectual properties will be used , as well as, to identify and make new classes to identify those services with special focusing on intellectual property rights in protecting and promoting those new services and goods under the Future brands. An open policy will be used to look for new ideas, to create new entities and to create infrastructures which would include on-line—means in which to market, to distribute and to create new ways for people's ideas etc. or anything which is created by thought process to be tested, produced, and marketed in any marketing sector. By electronic means building marketing sectors and infrastructures for promoting new products, as well as testing and evaluation of products and services can be done. Ideas, new licenses, franchises, distributorships and businesses in any marketing sector for any and all goods and services that can be identified as a service or good or product can be promoted and marketed to create a new company or companies on line with interconnecting infrastructures in any and all industries by any and all means not limited to just online. By licensing the name Future, and other enties, infranstructures will be established to test and to market ideas in any marketing sector, so forth.

8 process method is the creation and building of connecting infrastructure markets on line with web sites, etc. to allow testing, advertisment, marketing by any and all means in any and all marketing sectors and industries of the world. New ideas can be incorporated with other ideas for the creation of new products and services. Usage rights to a name brand and ideas could include every classification of services such as retail store, industrial, entertainment, eduation, radio/TV braodcasting, hotel, and any and all of services of now and of the future. Any name identified with products and services online establishes usage and legal rights and then classified as itellectual property licensing, so forth.

9 process methiod to invent or create and promote for manufacturers to manufacture and market licensed products under the Future name or names with intellectual property rights and to invent or discover new classes to license the Future rights. Interconnected infrastructures dealing with any marketing sector will be built. New markets for products and any services will be online interconnecting networks using websights where any and all thought processes can be tested, marketed and promoted by any and all means in and all fields. Interconnecting markets, so forth, and the method ways and means in which doing business including discovering, testing, promoting and marketing new products will be built around those new products, goods and services and intellectual property rights. Infrastructure on online, in the retail sectors, in industrial sectors and in anything which can be identified as service for goods or products can be protected and can be identified by name or trademark or patents. Protected are methods and any and all which can be claimed, any and all means of going busines, building interconnecting industries, markets for products and goods, so forth. future

10 process method is name and not limited to the name Future and claiming the process and the methods of building markets, interconnecting markets, infrastructures and anything online which will make it possible to test, promote, and market people's ideas in any marketing sector. I claim any and all ways of doing business in an interconnecting infrastructure and of building new networks and products and goods with new patents and intellectial property rights of discovered ideas and products which are to be identified by and not limited to the name Future.

11 claim process methiod creating marketing in retail store sectors, financial sectors, entertainment sectors, research sector, regular TV broadcasting sector, online sector, health care sector, and any service in any industry identified as such to be be interconnected by any and all means.

12. processs method to discover new technology news service as a new way of
